(19) United States
(12) Patent Application Publication
(10) Pub. No.: US 2018/0346723 A1
(43) Pub. Date: Dec. 6, 2018

(54) SILICONE RUBBER COMPOSITION AND SILICONE RUBBER CROSS-LINKED BODY, AND INTEGRALLY MOLDED BODY AND METHOD FOR PRODUCING INTEGRALLY MOLDED BODY

(71) Applicants: Sumitomo Riko Company Limited, Komaki-shi (JP); SumiRiko Fine Elastomer, Ltd., Ageo-shi (JP)

(72) Inventors: Takahiro Morita, Komaki-shi (JP); Yasunori Nimura, Komaki-shi (JP); Ryosuke Yamaoka, Komaki-shi (JP); Satoshi Suzuki, Komaki-shi (JP); Shigeru Fukagawa, Ageo-shi (JP); Tomohito Seki, Ageo-shi (JP)

(73) Assignees: Sumitomo Riko Company Limited, Komaki-shi (JP); SumiRiko Fine Elastomer, Ltd., Ageo-shi (JP)

(21) Appl. No.: 16/059,352

(22) Filed: Aug. 9, 2018

Related U.S. Application Data
(62) Division of application No. 15/358,912, filed on Nov. 22, 2016.
Application No. 15/358,912 is a continuation of application No. PCT/JP2015/077546, filed on Sep. 29, 2015.

(30) Foreign Application Priority Data
Sep. 29, 2014 (JP) 2014-199021
Nov. 26, 2014 (JP) 2014-239081

(51) Int. Cl. C08L 83/04; C09J 183/04; B29C 39/12; C09J 11/00; B29C 39/38; B32B 1/00; B32B 25/02; B32B 25/08; B32B 25/20; B32B 27/00; B32B 27/42; B32B 27/36; B32B 27/34; B32B 27/32; B32B 27/30; B32B 27/28; B32B 27/16; B29K 67/00; B29K 83/00

(52) U.S. Cl. CPC C08L 83/04; B32B 2307/70; B29C 39/12; C09J 11/00; B29C 39/38; B32B 1/00; B32B 25/02; B32B 25/08; B32B 25/20; B32B 27/00; B32B 27/42; B32B 27/36; B32B 27/34; B32B 27/32; B32B 27/308; B32B 27/304; B32B 27/302; B32B 27/285; B32B 27/16; B29K 2067/006; B29K 2083/005; B32B 2250/24; B32B 2270/00; B32B 2274/00; B32B 2307/548; C09J 183/04

(57) ABSTRACT

Provided is a silicone rubber composition that has excellent storage stability and an improved post-curing compression set, and a silicone rubber cross-linked body made from the silicone rubber composition. A silicone rubber composition contains (a) an organopolysiloxane, (b) a cross-linking agent, and (c) a microcapsule type catalyst that is made from resin microparticles encapsulating a cross-linking catalyst, wherein the resin of (c) is one of a thermosetting resin that is thermally cured in the presence of the cross-linking catalyst and a thermosetting resin that is thermally cured in the absence of the cross-linking catalyst.

### CROSS-REFERENCE TO RELATED APPLICATIONS

The present patent application is a Divisional of U.S. patent application Ser. No. 15/358,912, filed Nov. 22, 2016, which is a Continuation of International application No. PCT/JP2015/077546, filed Sep. 29, 2015, and claims priority from Japanese Applications Nos. 2014-239081 and 2014-199021, filed Nov. 26, 2014 and Sep. 29, 2014, respectively, all of which are incorporated herein by reference in their entireties.

### TECHNICAL FIELD

The present invention relates to a silicone rubber composition and a silicone rubber cross-linked body, and an integrally molded body and a method for producing an integrally molded body, and more particularly to a silicone rubber composition that is excellent in storage stability and a silicone rubber cross-linked body made from the silicone rubber composition, and an integrally molded body and a method for producing an integrally molded body.

### BACKGROUND ART

Patent Document 1 describes a thermosetting organic polymer composition containing a thermoplastic resin microparticulate catalyst that is made from thermoplastic resin microparticles containing a cross-linking catalyst in order to secure storage stability of the composition before curing.

### CITATION LIST

### Patent Literature

Patent Document 1: Patent JP2000-159896

### SUMMARY OF INVENTION

### Problems to be Solved by the Invention

In the thermosetting organic polymer composition described in Patent Document 1, the thermoplastic resin contained in the thermoplastic resin microparticulate catalyst is contained uncross-linked also after thermal curing. Thus, a compression set of the composition is deteriorated.

An object of the present invention is to provide a silicone rubber composition that has excellent storage stability and an improved post-curing compression set, and a silicone rubber cross-linked body made from the silicone rubber composition, and an integrally molded body and a method for producing an integrally molded body.

### Means of Solving the Problems

To achieve the objects and in accordance with the purpose of the present invention, a silicone rubber composition according to one embodiment of the present invention contains (a) an organopolysiloxane, (b) a cross-linking agent, and (c) a microcapsule type catalyst that is made from resin microparticles encapsulating a cross-linking catalyst. The resin of (c) is one of a thermosetting resin that is thermally cured in the presence of the cross-linking catalyst and a thermosetting resin that is thermally cured in the absence of the cross-linking catalyst.

It is preferable that the resin of (c) should be a thermosetting resin that is thermally cured in the presence of the cross-linking catalyst. It is preferable that the resin of (c) should be at least one of an unsaturated polyester resin, a polyvinyl butyral resin, and an epoxy resin. It is preferable that the resin of (c) should be a resin having a glass transition temperature in the range of 25 to 130 degrees C. It is preferable that the silicone rubber composition should further contain (d) an adhesion-imparting agent. It is preferable that (d) the adhesion-imparting agent should be a compound containing one or more selected from the group consisting of an alkoxysilyl group, a hydrosilyl group, and a silanol group.

According to another embodiment of the present invention, a silicone rubber cross-linked body is made of a cross-linked body of the above-described silicone rubber composition.

According to another embodiment of the present invention, an integrally molded body includes a thermoplastic resin molded body comprising a surface-treated surface, and a silicone rubber molded body. The silicone rubber molded body is made of the above-described silicone rubber composition that is cured in contact with the surface-treated surface of the thermoplastic resin molded body. The thermoplastic resin molded body is integrally molded with the silicone rubber molded body that is in contact with the thermoplastic resin molded body.

It is preferable that a surface treatment provided to the thermoplastic resin molded body should be one or more treatments selected from the group consisting of a corona treatment, a plasma treatment, a UV treatment, an electron beam treatment, an excimer treatment, and a flame treatment. It is preferable that the thermoplastic resin should be one or more resins selected from the group consisting of polyester, polycarbonate, polyamide, polyacetal, modified polyphenylene ether, polyolefin, polystyrene, polyvinyl chloride, an acrylic resin, and an acrylonitrile-butadiene-styrene copolymer.

According to another embodiment of the present invention, a method for producing an integrally molded body including a thermoplastic resin molded body and a silicone rubber molded body that is in contact with the thermoplastic resin molded body includes the steps of subjecting the thermoplastic resin molded body to a surface treatment, and forming the silicone rubber molded body by bringing a silicone rubber composition into contact with a surface-treated surface of the thermoplastic resin molded body and by curing the composition, the silicone rubber composition containing (a) an organopolysiloxane, (b) a cross-linking agent, and (c) a microcapsule type catalyst that is made from resin microparticles encapsulating a cross-linking catalyst. The resin of (c) is one of a thermosetting resin that is thermally cured in the presence of the cross-linking catalyst and a thermosetting resin that is thermally cured in the absence of the cross-linking catalyst.

### Advantageous Effects of Invention

With the silicone rubber composition according to the embodiment of the present invention, since the cross-linking catalyst of (c) is contained in the resin microparticles of (c), the cross-linking catalyst of (c) is prevented from being brought into contact with (a) the organopolysiloxane and (b) the cross-linking agent before thermal curing, so that the silicone rubber composition is excellent in storage stability. In addition, since the resin of (c) is one of the thermosetting resin that is thermally cured in the presence of the cross-linking catalyst and the thermosetting resin that is thermally cured in the absence of the cross-linking catalyst, the resin of (c) is also thermally cured when (a) the organopolysiloxane is thermally cured, so that the silicone rubber composition has an improved post-curing compression set.

With the integrally molded body and the method for producing an integrally molded body according to the embodiment of the present invention, since the cross-linking catalyst of the silicone rubber composition is the microcapsule type catalyst, the integrally molded body is excellent both in storage stability and low temperature moldability. While the silicone rubber composition contains the adhesion-imparting agent in addition to the microcapsule type cross-linking catalyst, the integrally molded body is excellent in adherence properties between the thermoplastic resin molded body and the silicone rubber molded body since the silicone rubber composition is cured in contact with the surface-treated surface of the thermoplastic resin molded body.

### BRIEF DESCRIPTION OF DRAWINGS

FIG. 1A is a DSC chart of a catalyst-free resin microparticles in which the resin of resin microparticles is an unsaturated polyester resin. FIG. 1B is a DSC chart of a microcapsule type catalyst (catalyst-containing resin microparticles) in which the resin of resin microparticles is an unsaturated polyester resin.

FIG. 2A is a DSC chart of a catalyst-free resin microparticles in which the resin of resin microparticles is a polyvinyl butyral resin. FIG. 2B is a DSC chart of a microcapsule type catalyst (catalyst-containing resin microparticles) in which the resin of resin microparticles is a polyvinyl butyral resin.

FIG. 3A is a DSC chart of a catalyst-free resin microparticles in which the resin of resin microparticles is an epoxy resin. FIG. 3B is a DSC chart of a microcapsule type catalyst (catalyst-containing resin microparticles) in which the resin of resin microparticles is an epoxy resin.

FIG. 4 is a cross-sectional view of an integrally molded body according to one embodiment of the present invention.

FIG. 5 is a schematic view of the relation of the interaction between (c) a microcapsule type platinum catalyst and (d) an adhesion-imparting agent, and the interaction between a thermoplastic resin molded body 12 and (d) the adhesion-imparting agent.

FIG. 6 is a schematic view of an integrally molded body produced in Examples.

### DESCRIPTION OF EMBODIMENTS

Hereinafter, detailed descriptions of one embodiment of the present invention will be provided.

A silicone rubber composition according to one embodiment of the present invention contains (a) an organopolysiloxane, (b) a cross-linking agent, and (c) a microcapsule type catalyst that is made from resin microparticles encapsulating a cross-linking catalyst.

(a) The organopolysiloxane has at least two functional groups that are to be cross-linked by (b) the cross-linking agent, in one molecule. Examples of (a) the organopolysiloxane include an alkenyl group-containing organopolysiloxane, a hydroxyl group-containing organopolysiloxane, a (meth)acryl group-containing organopolysiloxane, an isocyanate-containing organopolysiloxane, an amino group-containing organopolysiloxane, and an epoxy group-containing organopolysiloxane. The alkenyl group-containing organopolysiloxane is used as a main material for an addition curing type silicone rubber composition. The alkenyl group-containing organopolysiloxane is cross-linked by a hydrosilyl cross-linking agent in addition reaction with the hydrosilyl cross-linking agent. While proceeding even at room temperature, this addition reaction is promoted under heating. Thermal curing by this addition reaction is normally performed at 100 degrees C. or more, and preferably at 100 to 170 degrees C. A platinum catalyst is preferably used as a hydrosilylation catalyst in this addition reaction. The alkenyl group-containing organopolysiloxane preferably has at least two alkenyl groups in one molecule.

The organopolysiloxane has an organic group. The organic group defines a monovalent substituted or unsubstituted hydrocarbon group. Examples of the unsubstituted hydrocarbon group include an alkyl group such as a methyl group, an ethyl group, a propyl group, a butyl group, a hexyl group, and a dodecyl group, an aryl group such as a phenyl group, and an aralkyl group such as a β-phenylethyl group and a β-phenylpropyl group. Examples of the substituted hydrocarbon group include a chloromethyl group and a 3,3,3-trifluoropropyl group. In general, the organopolysiloxanes having a methyl group as the organic group are used from the viewpoint of easy synthesis. While an organopolysiloxane of a straight-chain type is preferable, a branched organopolysiloxane or a circular organopolysiloxane may be used. Examples of the alkenyl group include a vinyl group, an allyl group, a butenyl group, a pentenyl group, and a hexenyl group.

(b) The cross-linking agent defines a cross-linking agent for cross-linking (a) the organopolysiloxane. Examples of (b) the cross-linking agent include a hydrosilyl cross-linking agent, a sulfur cross-linking agent, and a peroxide cross-linking agent. The hydrosilyl cross-linking agent is used as a cross-linking agent for an addition curing type silicone rubber composition. The hydrosilyl cross-linking agent has a hydrosilyl group (SiH group) in its molecular structure. The hydrosilyl cross-linking agent defines a hydrosilyl group-containing organopolysiloxane (an organohydrogenpolysiloxane). The number of hydrosilyl groups in the molecular structure is not particularly limited: however, the number is preferably in the range of 2 to 50 from the viewpoint of being excellent in curing rate and stability. When the hydrosilyl cross-linking agent has two or more hydrosilyl groups in its molecular structure, the hydrosilyl groups are preferably present in different Si. The polysiloxane may be a chain polysiloxane or a circular polysiloxane. The hydrosilyl group-containing organopolysiloxane preferably has at least two hydrosilyl groups in one molecule. The number average molecular mass of the hydrosilyl cross-linking agent is preferably in the range of 200 to 30,000 from the viewpoint of being excellent in handling properties.

Specific examples of the hydrosilyl group-containing organopolysiloxane (organohydrogenpolysiloxane) include a methylhydrogenpolysiloxane with both terminals blocked with trimethylsiloxy groups, a dimethylsiloxane/methylhydrogensiloxane copolymer with both terminals blocked with trimethylsiloxy groups, a dimethylpolysiloxane with both terminals blocked with dimethylhydrogensiloxy groups, a dimethylsiloxane/methylhydrogensiloxane copolymer with both terminals blocked with dimethylhydrogensiloxy groups, a methylhydrogensiloxane/diphenylsiloxane copolymer with both terminals blocked with trimethylsiloxy groups, a methylhydrogensiloxane/diphenylsiloxane/dimethylsiloxane copolymer with both terminals blocked with trimethylsiloxy groups, a copolymer consisting of ½ unit of (CH₃)₂HSiO and 4/2 units of SiO, and a copolymer consisting of ½ unit of (CH₃)₂HSiO, 4/2 units of SiO, and 3/2 units of (C₆H₅)SiO.

The content of (b) the crosslinking agent is not particularly limited; however, the content is normally in the range of 0.1 to 40 parts by mass with respect to 100 parts by mass of (a) the organopolysiloxane.

The cross-linking catalyst of (c) defines a catalyst for promoting the crosslinking reaction of (a) the organopolysiloxane by (b) the crosslinking agent. Examples of the cross-linking catalyst of (c) include a platinum catalyst as a hydrosilylation catalyst, a ruthenium catalyst, and a rhodium catalyst. Examples of the platinum catalyst include microparticulate platinum, platinum black, platinum carrying carbon, platinum carrying silica, chloroplatinic acid, an alcohol solution of chloroplatinic acid, an olefin complex of platinum, and an alkenyl siloxane complex of platinum. Among them, a single kind of cross-linking catalyst may be used alone, or two or more kinds of cross-linking catalysts may be used in combination.

The resin of (c) is for microcapsulating the cross-linking catalyst of (c), and the cross-linking catalyst of (c) is encapsulated by the resin of (c). The resin that encapsulates the cross-linking catalyst is microparticulate. Microparticles are solid at least at room temperature, and have an average particle diameter of 30 μm or less. The average particle diameter is measured with the use of a laser microscope. The average particle diameter of the resin microparticles of (c) is preferably 10 μm or less, and more preferably 5 μm or less from the viewpoint of enhancing the dispersibility of the cross-linking catalyst or the like. In addition, the average particle diameter of the resin microparticles of (c) is preferably 0.1 μm or more, and more preferably 2 μm or more from the viewpoint of increasing the microparticle recovery rate at the time of producing.

The resin of (c) defines a thermosetting resin that is thermally cured in the presence of the cross-linking catalyst of (c) or in the absence of the cross-linking catalyst of (c). Whether the resin is a thermosetting resin can be checked by observing an exothermic peak indicating curing of the resin in a DSC measurement (differential scanning calorimetry). The thermosetting resin that is thermally cured in the absence of the cross-linking catalyst of (c) includes both of a resin that is thermally cured alone and a resin that is thermally cured by a curing agent.

Examples of the thermosetting resin that is thermally cured in the presence of the cross-linking catalyst of (c) or in the absence of the cross-linking catalyst of (c) include an unsaturated polyester resin, a polyvinyl butyral resin, an epoxy resin, a phenolic resin, a resol resin, an alkyd resin, a urea resin, a melamine resin, a polyurethane resin, and a diallyl phthalate resin. The unsaturated polyester resin defines a resin having an ester bond and an unsaturated bond (carbon-carbon double bond) in the main chain of the constituent molecules. Among them, a single kind of cross-linking catalyst of (c) may be used alone, or two or more kinds of cross-linking catalyst of (c) may be used in combination as the resin of (c). Among these resins, the unsaturated polyester resin, the polyvinyl butyral resin, and the epoxy resin are preferable from the viewpoint of being resins having molecular composition that does not inhibit the curing of silicone rubber.

The unsaturated polyester resin, the polyvinyl butyral resin, and the epoxy resin are thermally cured in the presence of a platinum catalyst. Examples of the platinum catalyst include the platinum catalyst that is exemplified as the hydrosilylation catalyst. In other words, these resins define a thermosetting resin that is thermally cured in the presence of the cross-linking catalyst of (c). In addition, the unsaturated polyester resin, the polyvinyl butyral resin, and the epoxy resin can be cured with the use of a curing agent. In other words, these resins define a thermosetting resin that is thermally cured in the absence of the cross-linking catalyst of (c). The curing agent is encapsulated in the resin microparticles of (c) together with the cross-linking catalyst of (c) or separately from the cross-linking catalyst (c). As the curing agent, a curing agent that does not inhibit curing of (a) the organopolysiloxane is preferable.

Examples of the curing agent for the unsaturated polyester resin include an epoxy resin. Examples of the curing agent for the polyvinyl butyral resin include a resin that reacts with a secondary hydroxyl group or a compound that reacts with a secondary hydroxyl group. Examples of the curing agent for the polyvinyl butyral resin include a phenol resin, an epoxy resin, a dialdehyde resin, and a phthalic anhydride. Examples of the curing agent for the epoxy resin include phenols, a phenol resin, and an acid anhydride. None of the exemplified resins or compounds inhibits curing of (a) the organopolysiloxane.

While the resin of (c) defines a thermosetting resin, a thermosetting resin that is thermally cured when (a) the organopolysiloxane is thermally cured is preferably used. When (a) the organopolysiloxane is an organopolysiloxane that is thermally cured by the above-described addition reaction and thermally cured at normal temperature, it is preferable that the resin of (c) should be thermally cured at the temperature in the range of 100 to 170 degrees C.

The resin of (c) defines a resin that softens at a temperature lower than the thermal curing temperatures of (a) the organopolysiloxane and the resin of (c). The Tg (glass transition temperature) of the resin of (c) is preferably 130 degrees C. or less, more preferably 100 degrees C. or less, and still more preferably 80 degrees C. or less although depending on the thermal curing temperature. Since the resin of (c) is solid at room temperature, the Tg of the resin of (c) is preferably a room temperature (25 degrees C.) or more. In addition, the Tg of the resin of (c) is preferably 40 degrees C. or more and more preferably 50 degrees C. or more from the viewpoint of stopping the cross-linking catalyst of (c) in the resin of (c) before curing to secure the storage stability.

(c) The microcapsule type catalyst can be produced in a conventionally known method, preferably in a suspension polymerization method, an emulsion polymerization method, an in-liquid drying method, or the like from the viewpoint of productivity and sphericity.

When (c) the microcapsule type catalyst is produced in the suspension polymerization method or the emulsion polymerization method, the cross-linking catalyst is made as a solid core material to be dispersed in an organic solvent that does not dissolve the cross-linking catalyst, and a monomer is polymerized in the dispersion liquid in a polymerization method such as a suspension polymerization method and an emulsion polymerization method, whereby the surface of the core material is coated with the polymer. Thus, a microcapsule-type catalyst in which a cross-linking catalyst is encapsulated by resin microparticles is obtained.

In producing (c) the microcapsule type catalyst in the in-liquid drying method, a cross-linking catalyst and a resin that encapsulates the cross-linking catalyst are dissolved in an organic solvent that is insoluble in water, and thus-prepared solution is dropped in a water solution of a surface acting agent to produce an emulsion. Then, after reducing the pressure to remove the organic solvent from the emulsion, an encapsulated catalyst is obtained by filtering the emulsion.

The content of the cross-linking catalyst of (c) the microcapsule type catalyst is preferably 50% by mass or less, and more preferably 24% by mass or less from the viewpoint of securing excellent storage stability because the cross-linking catalyst is coated sufficiently with the resin. In addition, the content is preferably 2% by mass or more, and more preferably 12% by mass or more from the viewpoint of securing excellent catalyst activity.

Although depending on the content of the cross-linking catalyst of (c) the microcapsule type catalyst, the content of (c) the microcapsule type catalyst in the composition is in the range of 0.01 to 5.0 parts by mass with respect to 100 parts by mass of (a) the organopolysiloxane when the content of the cross-linking catalyst of (c) the microcapsule type catalyst is within the above-described predetermined range. In addition, when the cross-linking catalyst is a metallic catalyst, the content is generally in the range of 1 ppm to 1.0 parts by mass in terms of the metallic amount with respect to 100 parts by mass of (a) the organopolysiloxane.

In addition to the above-described (a) to (c) materials, generally used additives such as a filler, a cross-linking accelerator, a cross-linking retarder, a cross-linking aid, an antiscorching agent, an anti-aging agent, a softening agent, a heat stabilizer, a flame retardant, a flame retardant aid, an ultraviolet absorber, a rust inhibitor, a conductive agent, and an antistatic agent may be added to the silicone rubber composition according to the present embodiment of the present invention if necessary within range of not adversely affecting the physical properties of the present invention and the silicone rubber. Examples of the filler include reinforcing fillers such as fumed silica, crystalline silica, wet silica, and fumed titanium oxide. The silicone rubber composition according to the present embodiment of the present invention can be prepared by mixing ingredients containing the above-described (a) to (c) materials.

The silicone rubber composition according to the present embodiment of the present invention is preferably liquid at room temperature from the viewpoint of formability. For this reason, at least (a) the organopolysiloxane is preferably liquid at room temperature. In addition, both of (a) the organopolysiloxane and (b) the cross-linking agent are preferably liquid at room temperature.

With the silicone rubber composition according to the present embodiment of the present invention having the above-described configuration, since the cross-linking catalyst of (c) is contained in the resin microparticles of (c), the cross-linking catalyst of (c) is prevented from being brought into contact with (a) the organopolysiloxane and (b) the cross-linking agent before thermal curing, so that the silicone rubber composition has excellent storage stability. In addition, since the resin of (c) is the thermosetting resin that is thermally cured in the presence of the cross-linking catalyst or in the absence of the cross-linking catalyst, the resin of (c) is also thermally cured when (a) the organopolysiloxane is thermally cured, so that the silicone rubber composition has an improved post-curing compression set.

The silicone rubber composition according to the present embodiment of the present invention forms a silicone rubber cross-linked body by thermally cured. The silicone rubber cross-linked body according to the present embodiment of the present invention is made of a cross-linked body of the silicone rubber composition according to the present embodiment of the present invention.

The silicone rubber composition according to the present embodiment of the present invention preferably has a compression set of 40% or less at 25% compression after thermal curing in a test of 150 degrees C.×70 hours, and 60% or less in a test of 175 degrees C.×22 hours. The compression sets are measured in accordance with the JIS K6262.

Next, a detailed description of the integrally molded body according to one embodiment of the present invention will be provided.

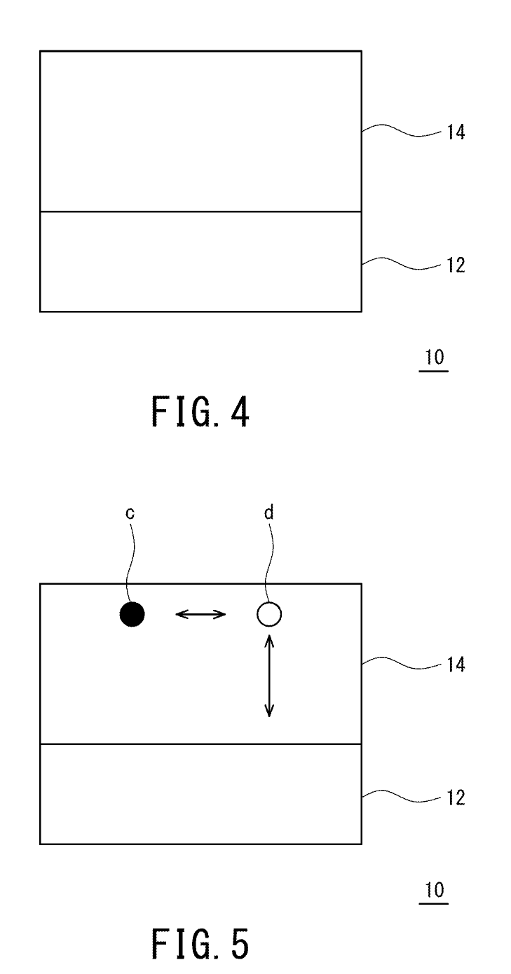

FIG. 4 shows the integrally molded body according to one embodiment of the present invention. An integrally molded body 10 includes a thermoplastic resin molded body 12 and a silicone rubber molded body 14. The thermoplastic resin molded body 12 and the silicone rubber molded body 14 are in contact with each other and bonded to each other on their contact interface. The silicone rubber molded body 14 is famed by bringing a silicone rubber composition into contact with a surface-treated surface of the thermoplastic resin molded body 12 and by curing the composition.

The silicone rubber composition used for the silicone rubber molded body 14 is the silicone rubber composition according to the above-described embodiment of the present invention. The silicone rubber composition according to the above-described embodiment of the present invention may further contain (d) an adhesion-imparting agent.

(d) The adhesion-imparting agent is for sufficiently bonding the silicone rubber composition to the surface of the thermoplastic resin molded body 12 when the silicone rubber composition is cured. (d) The adhesion-imparting agent is made of a compound having a functional group of interacting, for example, forming a bond with a functional group appearing on the surface of the thermoplastic resin molded body 12. Examples of the functional group include an alkoxysilyl group, a hydrosilyl group, and a silanol group. Thus, examples of the (d) the adhesion-imparting agent include a compound containing one or more groups selected from the group consisting of an alkoxysilyl group, a hydrosilyl group, and a silanol group.

Examples of the compound having an alkoxysilyl group include a silane coupling agent. The silane coupling agent defines a silane-based compound having two or more different functional groups in the molecule. Examples of the functional groups other than the alkoxysilyl group that the silane coupling agent has include a vinyl group, an epoxy group, a styryl group, and a (meth)acrylic group.

Specific examples of (d) the adhesion-imparting agent include p-styryl trimethoxysilane, phenyl-tri(dimethylsiloxy) silane, vinyl trimethoxysilane, 3-glycidoxypropyltrimethoxysilane, 3-methacryloxypropyltrimethoxysilane, and vinyl trihydroxysilane.

The content of (d) the adhesion-imparting agent is preferably 0.1 parts by mass or more with respect to 100 parts by mass of (a) the organopolysiloxane from the viewpoint of securing excellent adherence properties between the thermoplastic resin molded body 12 and the silicone rubber molded body 14. The content is more preferably 0.2 parts by mass or more, and still more preferably 0.5 parts by mass or more. On the other hand, the content of (d) the adhesion-imparting agent is preferably 20 parts by mass or less with respect to 100 parts by mass of (a) the organopolysiloxane from the viewpoint of deteriorating the rubber properties such as adhesion to a mold during molding and a compression set of the composition. The content is more preferably 10 parts by mass or less, and still more preferably 5 parts by mass or less.

The silicone rubber composition is preferably molded at a lower temperature since integrally molded with the thermoplastic resin molded body 12. The molding temperature is preferably 130 degrees C. or less, more preferably 110 degrees C. or less, and still more preferably 90 degrees C. or less. Setting the molding temperature of the silicone rubber composition to be 130 degrees C. or less can reduce defects of the thermoplastic resin molded body 12 such as burrs and deformation. In addition, lowering the molding temperature can reduce the energy cost in the molding process.

There arises a problem in that the silicone rubber composition has insufficient adherence properties to the thermoplastic resin molded body 12 when (c) the microcapsule type catalyst and (d) the adhesion-imparting agent are used together. This is because the adhesion-imparting function of (d) the adhesion-imparting agent is lowered because (c) the microcapsule type catalyst and (d) the adhesion-imparting agent interact, for example, react with each other. When the resin of (c) used for encapsulating the cross-linking catalyst of (c) is a resin containing a hydroxy group, a carboxyl group, a carbonyl group, an ether group, a phenyl group, a substituted phenyl group, or the like, the interaction of (c) the microcapsule type catalyst with (d) the adhesion-imparting agent is strong. When the resin of (c) is anyone of polyester, polyvinyl butyral, an epoxy resin, polystyrene, an acrylic resin, and a terpene resin, and (d) the adhesion-imparting agent is p-styryl trimethoxysilane, phenyl-tri(dimethylsiloxy)silane vinyl trimethoxysilane, 3-glycidoxypropyltrimethoxysilane, 3-methacryloxypropyltrimethoxysilane, or vinyl trihydroxysilane, the adhesion-imparting function of (d) the adhesion-imparting agent is remarkably lowered. For this reason, using an adhesion-imparting ingredient and a microcapsule type catalyst together in an integrally molded body of a thermoplastic resin and a silicone rubber is a contraindication to those skilled in the art.

In order to solve the problem, making the interaction between the thermoplastic resin molded body 12 and (d) the adhesion-imparting agent stronger than the interaction between (c) the microcapsule type catalyst and (d) the adhesion-imparting agent as shown in FIG. 5 allows (c) the microcapsule type catalyst and (d) the adhesion-imparting agent to be used together, which is a contraindication though. For this reason, in the present invention, a surface of the thermoplastic resin molded body 12 with which the silicone rubber composition is brought into contact is subjected to a surface treatment. This is because by performing the surface treatment, reactive sites on the surface of the thermoplastic resin molded body 12 with (d) the adhesion-imparting agent are increased, which makes the interaction between the thermoplastic resin molded body 12 and (d) the adhesion-imparting agent stronger than the interaction between (c) the microcapsule type catalyst and (d) the adhesion-imparting agent.

Examples of the surface treatment performed on the thermoplastic resin molded body 12 include a corona treatment, a plasma treatment, a UV treatment, an electron beam treatment, an excimer treatment, and a flame treatment. Among them, a single kind of surface treatment may be performed alone, or two or more kinds of surface treatments may be performed in combination. By subjecting the thermoplastic resin molded body 12 to the surface treatment, a predetermined functional group corresponding to the treatment method appears on the surface of the thermoplastic resin molded body 12. Then, this functional group interacts, for example, forms a bond with (d) the adhesion-imparting agent contained in the silicone rubber composition, so that the thermoplastic resin molded body 12 and the silicone rubber molded body 14 made from the silicone rubber composition that is in contact with the thermoplastic resin molded body 12 can be bonded to each other on their contact interface.

The thermoplastic resin molded body 12 is not particularly limited as long as the thermoplastic resin molded body 12 is integrally molded with the silicone rubber molded body 14, and can be appropriately selected depending on the intended use or the like. Examples of a connector housing used in an automotive waterproof connector include a connector housing molded into a predetermined shape made from a thermoplastic resin composition mainly made of polyester, polycarbonate, polyamide, polyacetal, modified polyphenylene ether, polyolefin, polystyrene, polyvinyl chloride, an acrylic resin, or an acrylonitrile-butadiene-styrene copolymer. Among them, a single kind of main material may be used alone, or two or more kinds of main materials may be used in combination. A general additive and the like may be appropriately added to the thermoplastic resin composition. Among the above-described main materials, polyester and polycarbonate are more preferred from the viewpoint of dimensional stability, strength, and the like.

The thermoplastic resin molded body 12 needs to be subjected to the surface treatment before being brought into contact with the silicone rubber composition, so that the thermoplastic resin molded body 12 is preferably molded into a predetermined shape in advance before being brought into contact with the silicone rubber composition. The silicone rubber composition is brought into contact with the surface-treated surface of the thermoplastic resin molded body 12 to be cured.

A method for producing an integrally molded body according to one embodiment of the present invention includes the steps of subjecting the thermoplastic resin molded body to the surface treatment, and forming the silicone rubber molded body by bringing the above-described silicone rubber composition into contact with the surface-treated surface of the thermoplastic resin molded body and by curing the composition as described above.

### EXAMPLES

A detailed description of the present invention will be provided with reference to Examples.

Preparation of a Microcapsule Type Catalyst

A xylene solution containing 20% by mass of a platinum catalyst, a coating resin for encapsulation, and dichloromethane were mixed at the ratio of 0.6:5:95 (mass ratio), and thus-prepared solution was dropped in a water solution of a surface acting agent to prepare an emulsion. Then, the dichloromethane was removed from the emulsion under reduced pressures and the emulsion was filtered, whereby microparticles containing the coating resin and the platinum catalyst were obtained. A microcapsule type catalyst having a predetermined average particle diameter was prepared in this manner. It is to be noted that the average particle diameter was measured with the use of a laser microscope.

Platinum catalyst: platinum chloride (IV) manufactured by FURUYA METAL CO., LTD.,

Coating Resins:
Unsaturated polyester resin: “UE-3350” (Tg=52 degrees C.) manufactured by UNITIKA LTD.
Polyvinyl butyral (PVB): “Mowital B30HH” (Tg=59 degrees C.) manufactured by KURARAY CO., LTD.
Epoxy resin: “EPICLON 4050” (Tg=56 degrees C.) manufactured by DIC CORPORATION
Unsaturated polyester resin: “UE-9900” (Tg=105 degrees C.) manufactured by UNITIKA LTD.
Acrylic resin: “ACRYPET MF” (Tg=87 degrees C.) manufactured by MITSUBISHI RAYON CO., LTD.
Silicone resin: “YR3370” (Tg=77 degrees C.) manufactured by MOMENTIVE PERFORMANCE MATERIALS INC. JAPAN
Polycarbonate resin (PC): “NOVAREX 7020R” (Tg=123 degrees C.) manufactured by MITSUBISHI ENGINEERING-PLASTICS CORPORATION Surface acting agent: Triton X-100 manufactured by WAKO PURE CHEMICAL INDUSTRIES, LTD.

Preparation of Catalyst-Free Resin Microparticles

Catalyst-free resin microparticles were prepared in the same method as the above-described microcapsule type catalyst, except that a xylene solution containing 20% by mass of a platinum catalyst was not added.

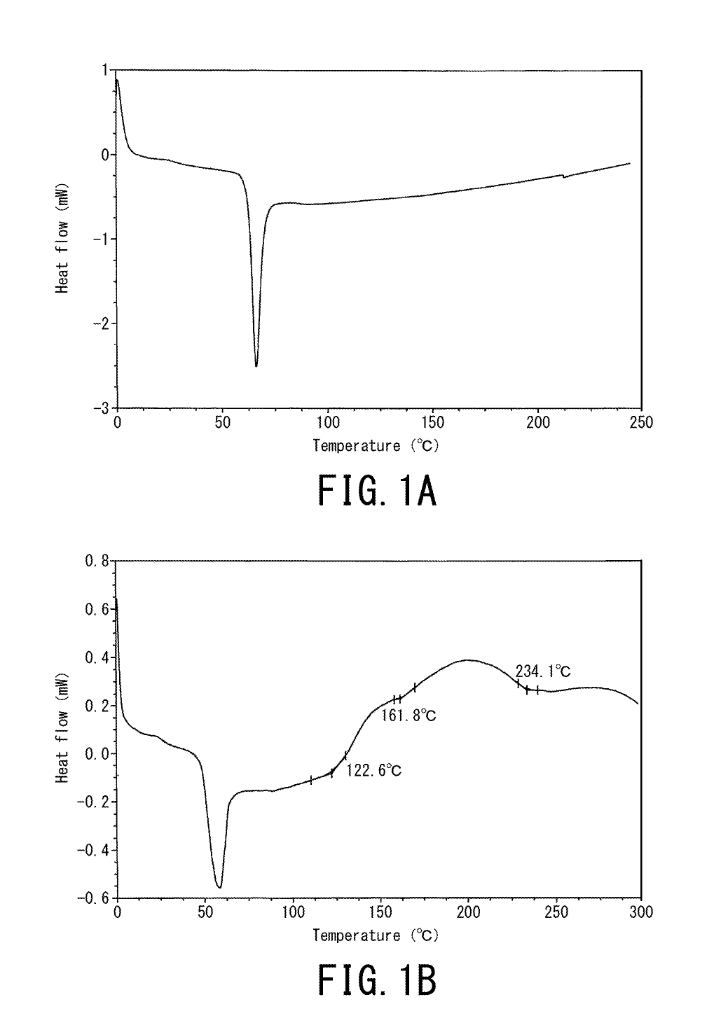

DSC measurements were carried out on the prepared catalyst-free resin microparticles and the microcapsule type catalyst (catalyst-containing resin microparticles). The results thereof are shown in FIGS. 1A to 3B. The sample amount was set to be 3.0 to 3.7 g, and the rate of temperature increase was set to be 10 degrees C./min.

FIG. 1: Unsaturated polyester resin, FIG. 1A: Catalyst-free resin microparticles, FIG. 1B: Microcapsule type catalyst

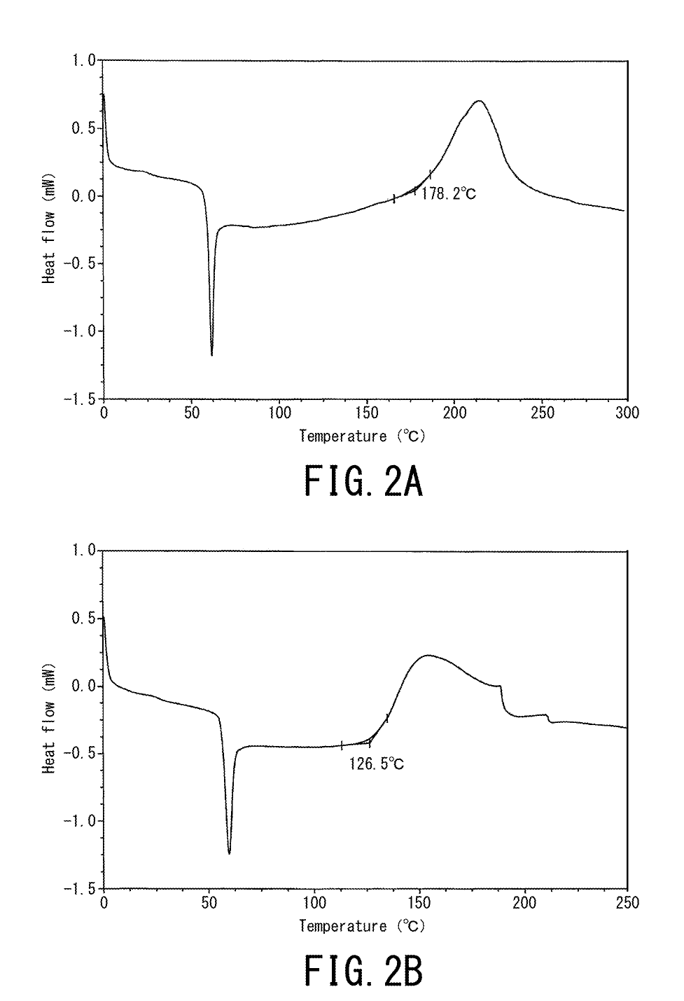

FIG. 2: Polyvinyl butyral resin, FIG. 2A: Catalyst-free resin microparticles, FIG. 2B: microcapsule type catalyst

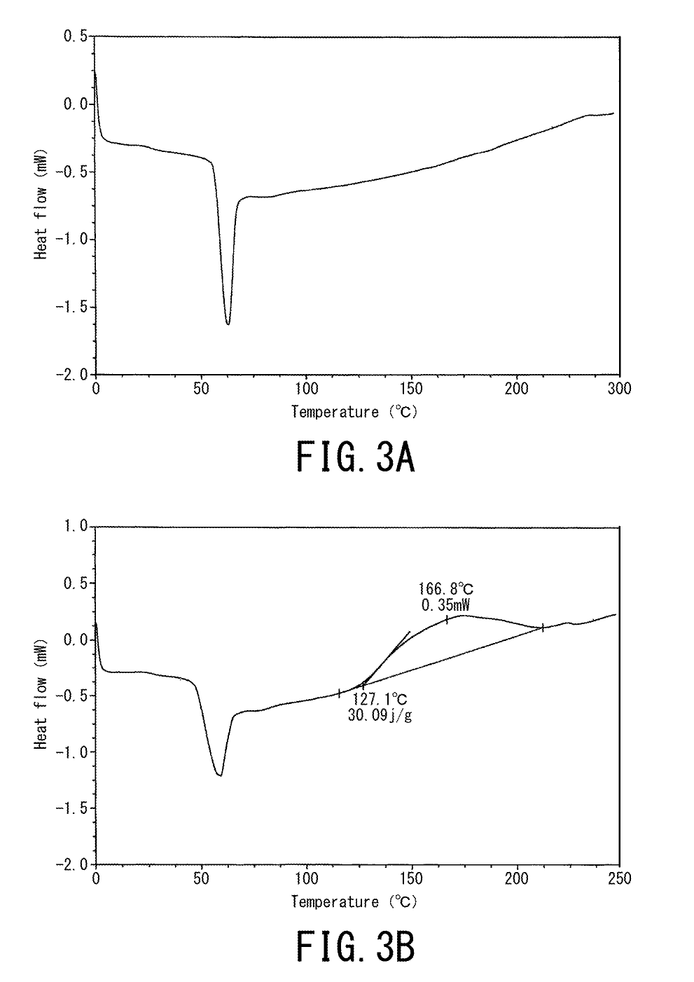

FIG. 3: Epoxy resin, FIG. 3A: Catalyst-free resin microparticles, FIG. 3B: microcapsule type catalyst

Concerning the unsaturated polyester resin, the endothermic peak indicating softening of the resin was observed at 52 degrees C. in FIG. 1. In addition, the exothermic peak indicating curing of the resin was observed on the higher temperature side than the endothermic peak both in the absence and presence of the platinum catalyst. This means that the unsaturated polyester resin has a Tg at 52 degrees C., and is thermally cured at temperatures higher than the softening temperature both in the absence and presence of the platinum catalyst. In addition, this means that the unsaturated polyester resin can be thermally cured in the range of 120 to 150 degrees C. in the presence of the platinum catalyst.

Concerning the polyvinyl butyral and the epoxy resin, the endothermic peaks indicating softening of the resins were observed at 59 degrees C. and 56 degrees C. in FIGS. 2 and 3, respectively. In addition, the exothermic peaks indicating curing of the resins were observed on the higher temperature sides than the endothermic peaks in the presence of the platinum catalyst while not observed in the absence of the platinum catalyst. This means that the polyvinyl butyral and the epoxy resin have a Tg at 59 degrees C. and a Tg at 56 degrees C., respectively, and are thermally cured at temperatures higher than the softening temperatures in the presence of the platinum catalyst. In addition, this means that the polyvinyl butyral and the epoxy resin can be thermally cured in the range of 120 to 150 degrees C. in the presence of the platinum catalyst.

Preparation of a Silicone Rubber Composition

### Examples 1 to 11

### Comparative Examples 2 to 3 and 5 to 6

(a) The organopolysiloxane and (c) the microcapsule type catalyst were mixed at the composition ratio (parts by mass) described in Tables 1 and 2, and then blended with the use of a planetary mixer for 30 minutes. Then, (b) the cross-linking agent was added to the mixture to be blended for another 30 minutes, and the mixture was vacuum degassed. Thus, addition curing type silicone rubber compositions in the form of a liquid were prepared.

(a) The organopolysiloxane: liquid silicone rubber (“DMS-V35” manufactured by GELEST, INC., a vinyl group-containing dimethylpolysiloxane)

(b) The cross-linking agent: a hydrosilylation cross-linking agent (“HMS-151” manufactured by GELEST, INC., a hydrosilyl group-containing dimethylpolysiloxane)

(c) The microcapsule type catalyst

### Comparative Examples 1 and 4

The addition curing type silicone rubber compositions in the form of a liquid were prepared in the same manner as the addition curing type silicone rubber composition according to Example 1, except that a non-microcapsule type catalyst (a xylene solution containing 20% by mass of a chloroplatinic acid manufactured by FURUYA METAL CO., LTD) was used in place of a microcapsule type catalyst.

Preparation of a Silicone Rubber Cross-Linked Body

Test pieces of silicone rubber cross-linked bodies having a diameter of 29±0.5 mm and a thickness of 6.3±0.3 mm were famed under the forming conditions described in Tables 1 and 2 (temperature, time). The conditions for the secondary cross-linking of the test pieces were set to be 200 degrees C.×4 hours.

The resulting silicone rubber compositions were evaluated in tams of storage stability. In addition, the compression sets were measured using the resulting test pieces of silicone rubber cross-linked bodies. The results are shown in Tables 1 and 2.

Storage Stability

After the addition curing type silicone rubber compositions were prepared, the viscosities thereof after having been left for 2 weeks at room temperature and normal humidity (viscometer: model TVB-10 viscometer manufactured by Toki Sangyo Co., Ltd.) were measured. The addition curing type silicone rubber compositions that had a viscosity increase rate of 50% or less were evaluated as “good”, and the addition curing type silicone rubber compositions that had a viscosity increase rate more than 50% were evaluated as “poor”.

Measurement of Compression Sets

Compression set tests were made under the conditions of 175 degrees C.×22 hours or under the conditions of 150 degrees C.×70 hours in accordance with the JIS K6262 method (25% compression). In the compression set tests under the conditions of 175 degrees C.×22 hours, the test pieces having compression set values of 60% or less were evaluated as “passed”, and the test pieces having compression set values more than 60% were evaluated as “failed”. In the compression set tests under the conditions of 150 degrees C.×70 hours, the test pieces having compression set values of 40% or less were evaluated as “passed”, and the test pieces having compression set values more than 40% were evaluated as “failed”.

TABLE 1

| | Example | | | | |
|---|---|---|---|---|---|
| | 1 | 2 | 3 | 4 | 5 |
| (a) Organopolysiloxane | 100 | 100 | 100 | 100 | 100 |
| (b) Cross-linking agent | 3 | 3 | 3 | 3 | 3 |
| (c) Micro-capsule type catalyst | 0.42 | 0.42 | 0.84 | 0.21 | 0.42 |
| Average particle diameter (μm) | 2 | 5 | 5 | 5 | 2 |
| Type of coating resin | Polyester | PVB | PVB | PVB | PVB |
| Thermal properties of coating resin | Thermosetting | Thermosetting | Thermosetting | Thermosetting | Thermosetting |
| Tg(° C.) of coating resin | 52 | 59 | 59 | 59 | 59 |
| Non-microcapsule type catalyst | — | — | — | — | — |
| Forming temperature (° C.) | 130 | 130 | 130 | 130 | 130 |
| Forming time (min.) | 15 | 15 | 15 | 15 | 15 |
| Compression set (% 175° C. 22 h) Primary cross- | 38 | 39 | 54 | 45 | 58 |
| linking | | | | | |
| Compression set (% 175° C. 22 h) Secondary cross- | 30 | 32 | 28 | 30 | 30 |
| linking | | | | | |
| Compression set Primary cross-linking | Passed | Passed | Passed | Passed | Passed |
| Compression set Secondary cross-linking | Passed | Passed | Passed | Passed | Passed |
| Storage stability | Good | Good | Good | Good | Good |
| | Example | | Comparative Example | | |
| | 6 | 7 | 1 | 2 | 3 |
| (a) Organopolysiloxane | 100 | 100 | 100 | 100 | 100 |
| (b) Cross-linking agent | 3 | 3 | 3 | 3 | 3 |
| (c) Micro-capsule type catalyst | 0.42 | 0.42 | — | 0.42 | 0.42 |
| Average particle diameter (μm) | 10 | 2 | — | 5 | 2 |
| Type of coating resin | PVB | Epoxy | — | Acrylic | Silicone |
| Thermal properties of coating resin | Thermosetting | Thermosetting | — | Thermosetting | Thermosetting |
| Tg(° C.) of coating resin | 59 | 56 | — | 87 | 77 |
| Non-microcapsule type catalyst | — | — | 0.045 | — | — |
| Forming temperature (° C.) | 130 | 130 | 130 | 130 | 130 |
| Forming time (min.) | 15 | 15 | 15 | 15 | 15 |
| Compression set (% 175° C. 22 h) Primary cross- | 47 | 43 | 33 | 68 | 79 |
| linking | | | | | |
| Compression set (% 175° C. 22 h) Secondary cross- | 31 | 33 | 24 | 36 | 40 |
| linking | | | | | |
| Compression set Primary cross-linking | Passed | Passed | Passed | Failed | Failed |
| Compression set Secondary cross-linking | Passed | Passed | Passed | Failed | Failed |
| Storage stability | Good | Good | Poor | Good | Poor |

TABLE 2

| | Example | | | | Comparative Example | | |
|---|---|---|---|---|---|---|---|
| | 8 | 9 | 10 | 11 | 4 | 5 | 6 |
| (a) Organopolysiloxane | 100 | 100 | 100 | 100 | 100 | 100 | 100 |
| (b) Cross-linking agent | 3 | 3 | 3 | 3 | 3 | 3 | 3 |
| (c) Micro-capsule type catalyst | 0.42 | 0.42 | 0.42 | 0.42 | — | 0.42 | 0.42 |
| Average particle diameter (μm) | 2 | 5 | 2 | 2 | — | 5 | 5 |
| Type of coating resin | Polyester | PVB | Epoxy | Polyester | — | Acrylic | PC |
| Thermal properties of coating resin | Thermosetting | Thermosetting | Thermosetting | Thermosetting | — | Thermosetting | Thermosetting |
| Tg(° C.) of coating resin | 52 | 59 | 56 | 105 | — | 87 | 123 |
| Non-microcapsule type catalyst | — | — | — | — | 0.045 | — | — |
| Forming temperature (° C.) | 120 | 120 | 120 | 120 | 120 | 120 | 150 |
| Forming time (min.) | 10 | 10 | 10 | 10 | 10 | 10 | 15 |
| Compression set (% 150° C. 70 h) | 30 | 37 | 30 | 32 | 24 | 51 | 56 |
| Primary cross-linking | | | | | | | |
| Compression set (% 150° C. 70 h) | 13 | 17 | 13 | 13 | 10 | 19 | 19 |
| Secondary cross-linking | | | | | | | |
| Compression set Primary cross-linking | Passed | Passed | Passed | Passed | Passed | Failed | Failed |
| Compression set Secondary cross-linking | Passed | Passed | Passed | Passed | Passed | Failed | Failed |
| Storage stability | Good | Good | Good | Good | Poor | Good | Good |

The silicone rubber compositions according to Comparative Examples 1 and 4 use a non-microcapsule type catalyst, and consequently do not satisfy storage stability. In the silicone rubber compositions according to Comparative Examples 2 to 3 and 5 to 6, the coating resins of the microcapsule type catalysts are thermoplastic resins, so that the compression sets are significantly worse than those of the silicone rubber compositions according to Comparative Examples 1 and 4. In contrast, in the silicone rubber compositions according to the present examples, the coating resins of the microcapsule type catalysts are thermosetting resins, so that the compression sets are not worse than those of the silicone rubber compositions according to Comparative Examples 1 and 4. In addition, the silicone rubber compositions according to the present examples use a microcapsule type catalyst, and are consequently excellent in storage stability.

Next, experiments were conducted on the integrally molded bodies.

Preparation of Microcapsule Type Platinum Catalysts <1 to 6> (MC-Type Platinum Catalysts <1 to 6>)

An IPA solution containing 3% by mass of a platinum catalyst, a coating resin for encapsulation, and dichloromethane were mixed at the ratio of 0.3:5:95 (mass ratio), and thus-prepared solution was dropped in a water solution of a surface acting agent to prepare an emulsion. Then, the dichloromethane was removed from the emulsion under reduced pressures and the emulsion was filtered, whereby microparticles containing the coating resin and the platinum catalyst were obtained. A microcapsule type catalyst having a predetermined average particle diameter was prepared in this manner. Platinum catalyst: platinum chloride (IV) manufactured by FURUYA METAL CO., LTD.

### Coating Resins:

<1>: Polyester “UE-3350” (Tg=52 degrees C.) manufactured by UNITIKA LTD.
<2>: Polyvinyl butyral (PVB): “Mowital B30HH” (Tg=63 degrees C.) manufactured by KURARAY CO., LTD.
<3>: Polystyrene (PS) “YS RESIN SX100” manufactured by YASUHARA CHEMICAL CO., LTD.
<4>: Epoxy resin (EP) “jER1001” (Tg=52 degrees C.) manufactured by MITSUBISHI CHEMICAL CORPORATION
<5>: Acrylic resin “Hi-Pearl T-8252” (Tg=81 degrees C.) manufactured by NEGAMI CHEMICAL INDUSTRIAL CO., LTD.
<6>: Terpene resin “YS RESIN PX800” manufactured by YASUHARA CHEMICAL CO., LTD.
Surface acting agent: Triton X-100 manufactured by WAKO PURE CHEMICAL INDUSTRIES, LTD.

### Experimental Example 1

Preparation of an Addition Curing Type Silicone Rubber Composition

100 parts by mass of liquid silicone rubber (“DMS-V35” manufactured by GELEST, INC., a vinyl group-containing dimethylpolysiloxane), 0.8 parts by mass of an MC-type platinum catalyst <1>(0.05 parts by mass in tams of a platinum catalyst), and 1 part by mass of a p-styryl trimethoxysilane (manufactured by SHIN-ETSU CHEMICAL CO., LTD.) that defines an adhesion-imparting agent <1> were mixed, and then blended with the use of a planetary mixer for 30 minutes. Then, 4 parts by mass of a hydrosilylation cross-linking agent (“HMS-151” manufactured by GELEST, INC., a hydrosilyl group-containing dimethylpolysiloxane) was added to the mixture to be blended for another 30 minutes, and the mixture was vacuum degassed. Thus, an addition curing type silicone rubber composition <1> in the form of a liquid was prepared.

Production of an Integrally Molded Body

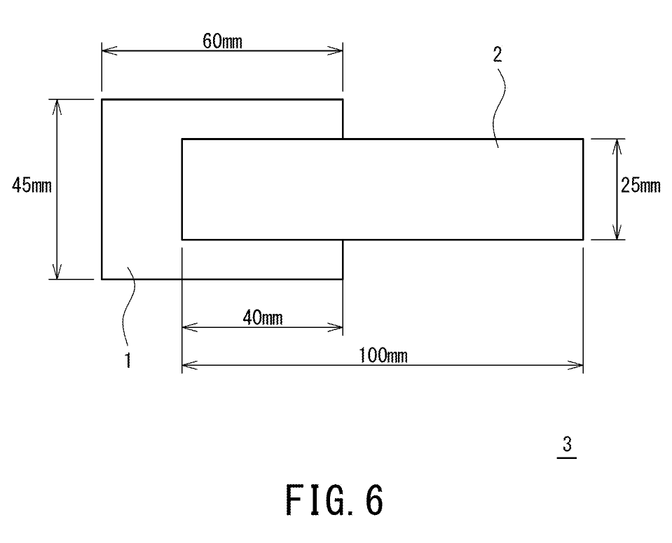

A polybutylene terephthalate resin (“TORAYCON 1401X06” manufactured by TORAY INDUSTRIES, INC.) was temperature adjusted at 250 degrees C., and casted into a mold at 100 degrees C. Then, a portion of the polybutylene terephthalate resin with which the silicone rubber composition was brought into contact was subjected to a plasma treatment (output 200 W), and the silicone rubber composition <1> was casted into the mold to be cured at 100 degrees C. Thus, an integrally molded body 3 including a PBT molded body 1 (having a thickness of 3 mm) and a silicone rubber molded body 2 (having a thickness of 5 mm) as shown in FIG. 6 was produced.

### Experimental Example 2

An integrally molded body according to Experimental Example 2 was produced in the same manner as the integrally molded body according to Experimental Example 1, except that the molding temperature of the addition curing type silicone rubber composition was changed from 90 degrees C. to 130 degrees C.

### Experimental Example 3

An integrally molded body according to Experimental Example 3 was produced in the same manner as the integrally molded body according to Experimental Example 1, except that 1 part by mass of phenyl-tri (dimethylsiloxy) silane (manufactured by GELEST, INC.) was used as an adhesion-imparting agent <2> in place of the adhesion-imparting agent <1> in preparing the addition curing type silicone rubber composition.

### Experimental Example 4

An integrally molded body according to Experimental Example 4 was produced in the same manner as the integrally molded body according to Experimental Example 1, except that 1 part by mass of vinyl trihydroxysilane (made by the hydrolysis of vinyl trimethoxysilane manufactured by SHIN-ETSU CHEMICAL CO., LTD.) was used as an adhesion-imparting agent <3> in place of the adhesion-imparting agent <1> in preparing the addition curing type silicone rubber composition.

### Experimental Example 5

An integrally molded body according to Experimental Example 5 was produced in the same manner as the integrally molded body according to Experimental Example 1, except that an acrylic resin (“ACRYPET VH” manufactured by MITSUBISHI RAYON CO., LTD.) was used as a thermoplastic resin in place of the PBT in producing the integrally molded body.

### Experimental Example 6

An integrally molded body according to Experimental Example 6 was produced in the same manner as the integrally molded body according to Experimental Example 1, except that the surface treatment performed on the thermoplastic resin was replaced with a UV treatment (output 2 kW, 10 s) in producing the integrally molded body.

### Experimental Example 7

An integrally molded body according to Experimental Example 7 was produced in the same manner as the integrally molded body according to Experimental Example 6, except that the MC-type platinum catalyst was replaced with the MC-type platinum catalyst <2>.

### Experimental Example 8

An integrally molded body according to Experimental Example 8 was produced in the same manner as the integrally molded body according to Experimental Example 7, except that the molding temperature of the addition curing type silicone rubber composition was changed from 90 degrees C. to 130 degrees C.

### Experimental Example 9

An integrally molded body according to Experimental Example 9 was produced in the same manner as the integrally molded body according to Experimental Example 7, except that 1 part by mass of phenyl-tri(dimethylsiloxy) silane (manufactured by GELEST, INC.) was used as an adhesion-imparting agent <2> in place of the adhesion-imparting agent <1> in preparing the addition curing type silicone rubber composition.

### Experimental Example 10

An integrally molded body according to Experimental Example 10 was produced in the same manner as the integrally molded body according to Experimental Example 7, except that 1 part by mass of vinyl trihydroxysilane (made by the hydrolysis of vinyl trimethoxysilane manufactured by SHIN-ETSU CHEMICAL CO., LTD.) was used as an adhesion-imparting agent <3> in place of the adhesion-imparting agent <1> in preparing the addition curing type silicone rubber composition.

### Experimental Example 11

An integrally molded body according to Experimental Example 11 was produced in the same manner as the integrally molded body according to Experimental Example 7, except that an acrylic resin (“ACRYPET VH” manufactured by MITSUBISHI RAYON CO., LTD.) was used as a thermoplastic resin in place of the PBT in producing the integrally molded body.

### Experimental Examples 12 to 15

Integrally molded bodies according to Experimental Examples 12 to 15 were prepared in the same manner as the integrally molded body according to Experimental Example 7, except that the MC-type platinum catalyst was replaced with the MC-type platinum catalysts <3> to <6>, respectively.

### Experimental Example 16

An integrally molded body according to Experimental Example 16 was produced in the same manner as the integrally molded body according to Experimental Example 1, except that the surface treatment performed on the thermoplastic resin was replaced with a flame treatment (Air amount 100 L/min, Gas amount 4 LPG) in producing the integrally molded body.

### Experimental Example 21

An integrally molded body according to Experimental Example 21 was produced in the same manner as the integrally molded body according to Experimental Example 1, except that an IPA solution containing 3% by mass of a non-MC-type platinum catalyst (chloroplatinic acid manufactured by FURUYA METAL CO., LTD.) was used in place of the MC-type platinum catalyst <1>, and 0.1 parts by mass of a retarder (1-ethynyl-1-cyclohexanol) was added thereto in preparing the addition curing type silicone rubber composition, and except that no surface treatment was performed on the thermoplastic resin and the molding temperature of the addition curing type silicone rubber composition was changed from 90 degrees C. to 150 degrees C. in producing the integrally molded body.

### Experimental Example 22

An integrally molded body according to Experimental Example 22 was produced in the same manner as the integrally molded body according to Experimental Example 1, except that an IPA solution containing 3% by mass of a non-MC-type platinum catalyst (chloroplatinic acid manufactured by FURUYA METAL CO., LTD.) was used in place of the MC-type platinum catalyst <1> in preparing the addition curing type silicone rubber composition, and except that no surface treatment was performed on the thermoplastic resin in producing the integrally molded body.

### Experimental Example 23

An integrally molded body according to Experimental Example 23 was produced in the same manner as the integrally molded body according to Experimental Example 1, except that no surface treatment was performed on the thermoplastic resin in producing the integrally molded body.

Each of thus-prepared addition curing type silicone rubber compositions was evaluated in tams of storage stability, and the cross-linking rate. In addition, each of thus-produced integrally molded bodies was evaluated in tams of presence of defects in resins, molded energy, and adherence properties. Evaluation methods are as follows. The results are shown in Tables 3 and 4.

Storage Stability

After the addition curing type silicone rubber compositions were prepared, the viscosities thereof after having been left for 2 weeks at room temperature and normal humidity (viscometer: model TVB-10 viscometer manufactured by Toki Sangyo Co., Ltd.) were measured. The addition curing type silicone rubber compositions that had a viscosity increase rate of 50% or less were evaluated as “good”, the addition curing type silicone rubber compositions that had a viscosity increase rate more than 50% while being uncured were evaluated as “average”, and the addition curing type silicone rubber compositions that had a viscosity increase rate more than 50% while cured were evaluated as “poor”.

Cross-Linking Rate

The cross-linking rates of the addition curing type silicone rubber compositions were measured with the use of a rotorless rheometer manufactured by TOYO SEIKI SEISAKU-SHO, LTD., assuming that t90 was a time in which the addition curing type silicone rubber compositions reached 90% of the maximum torque at each molding temperature. The addition curing type silicone rubber compositions that had the time within 60 seconds were evaluated as “good”, and the addition curing type silicone rubber compositions that had the time exceeding 60 seconds were evaluated as “poor”.

Defects in Resin

The integrally molded bodies were checked for presence or absence of burrs and defamation occurring in the thermoplastic resins at each molding temperature. The integrally molded bodies in which burrs and defamation occurred in the thermoplastic resins were evaluated as “poor”, and the integrally molded bodies in which no burrs and deformation occurred in the thermoplastic resins were evaluated as “good”.

Molding Energy

Let the energy cost for molding an integrally molded body at 150 degrees C. be 100%. The integrally molded bodies that were molded at the energy cost of 90 to 100% were evaluated as “poor”, the integrally molded bodies that were molded at the energy cost of 70 to 90% were evaluated as “good”, and the integrally molded bodies that were molded at the energy cost of 70% or less were evaluated as “very good”.

Adherence Properties

Evaluations of the integrally molded bodies in terms of adherence properties were made by conducting a debonding test at 90 degrees C. on each of the integrally molded bodies in accordance with the JIS K6256-2. The integrally molded bodies that were not debonded on their contact interfaces and their silicone rubber was broken in the tests were evaluated as “good”, the integrally molded bodies that were debonded on their contact interfaces while their silicone rubber remained on their contact interfaces in the tests were evaluated as “average”, and the integrally molded bodies that were debonded on their contact interfaces while no silicone rubber remained on their contact interfaces in the tests were evaluated as “poor”.

TABLE 3

| | Experimental Example | | | | | | | | | | |
|---|---|---|---|---|---|---|---|---|---|---|---|
| | 1 | 2 | 3 | 4 | 5 | 6 | 7 | 8 | 9 | 10 | 11 |
| (a) Alkenyl group- | 100 | 100 | 100 | 100 | 100 | 100 | 100 | 100 | 100 | 100 | 100 |
| containing | | | | | | | | | | | |
| polysiloxane | | | | | | | | | | | |
| (b) Hydrosilyl | 4 | 4 | 4 | 4 | 4 | 4 | 4 | 4 | 4 | 4 | 4 |
| cross-linking | | | | | | | | | | | |
| agent | | | | | | | | | | | |
| (c) MC-type | 0.8 | 0.8 | 0.8 | 0.8 | 0.8 | 0.8 | — | — | — | — | — |
| platinum catalyst | | | | | | | | | | | |
| <1> Resin: | | | | | | | | | | | |
| Polyester | | | | | | | | | | | |
| (c) MC-type | — | — | — | — | — | — | 0.8 | 0.8 | 0.8 | 0.8 | 0.8 |
| platinum catalyst | | | | | | | | | | | |
| <2> Resin: | | | | | | | | | | | |
| Polyvinyl | | | | | | | | | | | |
| butyral | | | | | | | | | | | |
| (c) MC-type | — | — | — | — | — | — | — | — | — | — | — |
| platinum catalyst | | | | | | | | | | | |
| <3> Resin: | | | | | | | | | | | |
| Polystyrene | | | | | | | | | | | |
| (c) MC-type | — | — | — | — | — | — | — | — | — | — | — |
| platinum catalyst | | | | | | | | | | | |
| <4> Resin: Epoxy | | | | | | | | | | | |
| resin | | | | | | | | | | | |
| (c) MC-type | — | — | — | — | — | — | — | — | — | — | — |
| platinum catalyst | | | | | | | | | | | |
| <5> Resin: Acrylic | | | | | | | | | | | |
| resin | | | | | | | | | | | |
| (c) MC-type | — | — | — | — | — | — | — | — | — | — | — |
| platinum catalyst | | | | | | | | | | | |
| <6> Resin: | | | | | | | | | | | |
| Terpene resin | | | | | | | | | | | |
| (d) Adhesion- | 1 | 1 | — | — | 1 | 1 | 1 | 1 | — | — | 1 |
| imparting agent | | | | | | | | | | | |
| <1>: p-styryl | | | | | | | | | | | |
| trimethoxysilane | | | | | | | | | | | |
| (d) Adhesion- | — | — | 1 | — | — | — | — | — | 1 | — | — |
| imparting agent | | | | | | | | | | | |
| <2>: Phenyl- | | | | | | | | | | | |
| tri(dimethylsiloxy) | | | | | | | | | | | |
| silane | | | | | | | | | | | |
| (d) Adhesion- | — | — | — | 1 | — | — | — | — | — | 1 | — |
| imparting agent | | | | | | | | | | | |
| <3>: Vinyl | | | | | | | | | | | |
| trihydroxysilane | | | | | | | | | | | |
| Retarder | — | — | — | — | — | — | — | — | — | — | — |
| Non-MC-type | — | — | — | — | — | — | — | — | — | — | — |
| platinum catalyst | | | | | | | | | | | |
| Molding | 90 | 130 | 90 | 90 | 90 | 90 | 90 | 130 | 90 | 90 | 90 |
| tempearture | | | | | | | | | | | |
| (° C.) | | | | | | | | | | | |
| Thermoplastic | PBT | PBT | PBT | PBT | Acrylic | PBT | PBT | PBT | PBT | PBT | Acrylic |
| resin | | | | | | | | | | | |
| Surface treatment | Performed | performed | performed | performed | performed | Not | Not | Not | Not | Not | Not |
| (Plasma treatment) | | | | | | performed | performed | performed | performed | performed | performed |
| Surface treatment | Not | Not | Not | Not | Not | performed | performed | performed | performed | performed | performed |
| (UV treatment) | performed | performed | performed | performed | performed | | | | | | |
| Surface treatment | Not | Not | Not | Not | Not | Not | Not | Not | Not | Not | Not |
| (flame treatment) | performed | performed | performed | performed | performed | performed | performed | performed | performed | performed | performed |
| Storage stability | Good | Good | Good | Good | Good | Good | Good | Good | Good | Good | Good |
| Cross-linking | Good | Good | Good | Good | Good | Good | Good | Good | Good | Good | Good |
| rate (t90) | | | | | | | | | | | |
| Reduction of | Good | Good | Good | Good | Good | Good | Good | Good | Good | Good | Good |
| defectin resin | | | | | | | | | | | |
| Molding energy | Very good | Good | Very good | Very good | Very good | Very good | Very good | Good | Very good | Very good | Very good |
| Adherence | Good | Good | Good | Good | Good | Good | Good | Good | Good | Good | Good |
| properties | | | | | | | | | | | |

TABLE 4

| | Experimental Example | | | | | Experimental Example | | |
|---|---|---|---|---|---|---|---|---|
| | 12 | 13 | 14 | 15 | 16 | 21 | 22 | 23 |
| (a) Alkenyl group-containing | 100 | 100 | 100 | 100 | 100 | 100 | 100 | 100 |
| polysiloxane | | | | | | | | |
| (b) Hydrosilyl cross-linking agent | 4 | 4 | 4 | 4 | 4 | 4 | 4 | 4 |
| (c) MC-type platinum catalyst <1> | — | — | — | — | 0.8 | — | — | 0.8 |
| Resin: Polyester | | | | | | | | |
| (c) MC-type platinum catalyst <2> | — | — | — | — | — | — | — | — |
| Resin: Polyvinyl butyral | | | | | | | | |
| (c) MC-type platinum catalyst <3> | 0.8 | — | — | — | — | — | — | — |
| Resin: Polystyrene | | | | | | | | |
| (c) MC-type platinum catalyst <4> | — | 0.8 | — | — | — | — | — | — |
| Resin: Epoxy resin | | | | | | | | |
| (c) MC-type platinum catalyst <5> | — | — | 0.8 | — | — | — | — | — |
| Resin: Acrylic resin | | | | | | | | |
| (c) MC-type platinum catalyst <6> | — | — | — | 0.8 | — | — | — | — |
| Resin: Terpene resin | | | | | | | | |
| (d) Adhesion-imparting agent <1>: | 1 | 1 | 1 | 1 | 1 | 1 | 1 | 1 |
| p-styryl trimethoxysilane | | | | | | | | |
| (d) Adhesion-imparting agent <2>: | — | — | — | — | — | — | — | — |
| Phenyl-tri(dimethylsiloxy) silane | | | | | | | | |
| (d) Adhesion-imparting agent <3>: | — | — | — | — | — | — | — | — |
| Vinyl trihydroxysilane | | | | | | | | |
| Retarder | — | — | — | — | — | 0.1 | — | — |
| Non-MC-type platinum catalyst | — | — | — | — | — | 0.05 | 0.05 | — |
| Thermoplastic resin | PBT | PBT | PBT | PBT | PBT | PBT | PBT | PBT |
| Surface treatment (Plasma treatment) | Not | Not | Not | Not | Not | Not | Not | Not |
| | performed | performed | performed | performed | performed | performed | performed | performed |
| Surface treatment (UV treatment) | performed | performed | performed | performed | Not | Not | Not | Not |
| | | | | | performed | performed | performed | performed |
| Surface treatment (flame treatment) | Not | Not | Not | Not | performed | Not | Not | Not |
| | performed | performed | performed | performed | | performed | performed | performed |
| Storage stability | Good | Good | Good | Good | Good | Good | Poor | Good |
| Cross-linking rate (t90) | Good | Good | Good | Good | Good | Good | Good | Good |
| Reduction of defect in resin | Good | Good | Good | Good | Good | Poor | Good | Good |
| Molding energy | Very good | Very good | Very good | Very good | Very good | Poor | Very good | Very good |
| Adherence properties | Good | Good | Good | Good | Good | Good | Average | Poor |

In the integrally molded bodies according to Experimental Examples 21 and 22, the non-microcapsule platinum type catalysts were used in the addition curing type silicone rubber compositions. When a retarder was used in order to secure storage stability, the integrally molded body could be molded only if the molding temperature was set to be higher temperatures like the integrally molded body according to Experimental Example 21; however, having a high molding temperature of 150 degrees C., the integrally molded body according to Experimental Example 21 requires high molding energy and has a defect in resin. When no retarder was used, the integrally molded body could be molded at low temperatures like the integrally molded body according to Experimental Example 22 while storage stability was not satisfied. In addition, when the surface treatment was not performed on the thermoplastic resin molded body while the microcapsule type catalyst was used like the integrally molded body according to Experimental Example 23, adherence properties were not satisfied.

In contrast, in the integrally molded bodies according to Experimental Examples 1 to 16, the microcapsule type platinum catalysts and the adhesion-imparting agents were used in the addition curing type silicone rubber compositions, and the surfaces of the thermoplastic resin molded bodies with which the addition curing type silicone rubber compositions were brought into contact were subjected in advance to the surface treatments. Thus, the integrally molded bodies according to Experimental Examples 1 to 16 are excellent in adherence properties between the thermoplastic resin molded bodies and the silicone rubber molded bodies. In addition, since the microcapsule type platinum catalysts were used in the addition curing type silicone rubber compositions, the integrally molded bodies according to Experimental Examples 1 to 16 are excellent in storage stability without adding a retarder, and also satisfy low temperature moldability.

While the embodiments and examples of the present invention have been described in detail, the present invention is not limited to the above-described embodiments and examples, and various modifications can be made without departing from the gist of the present invention.

1. A silicone rubber cross-linked body comprising a silicone rubber composition comprising:
(a) an organopolysiloxane;
(b) a cross-linking agent; and
(c) a microcapsule type catalyst that comprises resin microparticles encapsulating a cross-linking catalyst,
wherein the resin of the microcapsule type catalyst (c) comprises a thermosetting resin that is thermally cured in the presence of the cross-linking catalyst or in the absence of the cross-linking catalyst, and softens at a temperature lower than thermal curing temperatures of the organopolysiloxane (a) and the resin of the microcapsule type catalyst (c),
the resin of the microcapsule type catalyst (c) has a glass transition temperature of 40° C. or higher and 130° C. or lower,
the resin microparticles of the microcapsule type catalyst (c) have an average particle diameter of 2 μm or larger and 10 μm or smaller,
the content of the microcapsule type catalyst in the silicone rubber composition is within a range of 0.01 to 5.0 parts by mass with respect to 100 parts by mass of the organopolysiloxane (a), and
the silicone rubber composition after thermal curing has a compression set of 40% or less in a test of 150° C.×70 hours, and 60% or less in a test of 175° C.×22 hours measured in accordance with JIS K6262 at 25% compression.

2. The silicone rubber cross-linked body according to claim 1, wherein the resin of the microcapsule type catalyst (c) is a polyvinyl butyral resin.

3. The silicone rubber cross-linked body according to claim 1, wherein the resin of the microcapsule type catalyst (c) is an unsaturated polyester resin.

4. The silicone rubber cross-linked body according to claim 1, wherein the resin of the microcapsule type catalyst (c) is an epoxy resin.
